(19) United States
(12) Patent Application Publication
(10) Pub. No.: US 2011/0036720 A1
(43) Pub. Date: Feb. 17, 2011

(54) MICROSTRUCTURE AND MANUFACTURING METHOD THEREOF

(75) Inventors: Yoshiharu Tagawa, Haibara-gun (JP); Yusuke Hatanaka, Haibara-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 12/988,238

(22) PCT Filed: Apr. 28, 2009
(86) PCT No.: PCT/JP2009/058381

§ 371 Date: Oct. 15, 2010

(30) Foreign Application Priority Data
Apr. 28, 2008 (JP) 2008-117264

(51) Int. Cl. B32B 3/26; C25D 5/00

(52) U.S. Cl. 205/50; 205/96

(57) ABSTRACT

Disclosed is a structure that has a thickness of 100 μm or greater and has regular micropores. A microstructure includes an aluminum or aluminum alloy oxide film which has cylindrical micropores extending from a bottom surface to a top surface of the microstructure. The micropores are arrayed at the bottom surface so as to have a degree of ordering as defined by general formula (1) of at least 70%, the center-to-center distance between neighboring micropores is from 300 to 600 nm and the axial length of the micropores is at least 100 μm.

### TECHNICAL FIELD

The present invention relates to a microstructure and more specifically a microstructure which is a thick film having a long-period micropore array and manufacturing method thereof.

### BACKGROUND ART

In the technical field of metal and semiconductor thin films, wires and dots, the movement of free electrons becomes confined at sizes smaller than some characteristic length, as a result of which singular electrical, optical and chemical phenomena become observable. Such phenomena are called “quantum mechanical size effects” or simply “quantum size effects.” Functional materials which employ such singular phenomena are under active research and development. Specifically, materials having structures smaller than several hundred nanometers in size, typically called microstructures or nanostructures, are the subject of current efforts in material development.

Methods for manufacturing such microstructures include processes in which a nanostructure is directly manufactured by semiconductor fabrication technology, including micropatterning technology such as photolithography, electron beam lithography, or x-ray lithography.

Of particular note is the considerable amount of research being conducted on processes for manufacturing microstructures having ordered micropores.

One method of forming an ordered structure in a self-regulating manner is illustrated by an anodized alumina film (anodized film) obtained by subjecting aluminum to anodizing treatment in an electrolytic solution. It is known that a plurality of micropores having diameters of about several nanometers to about several hundreds of nanometers are formed in a regular arrangement within the anodized film. It is also known that when a completely ordered arrangement is obtained by the self-ordering treatment of this anodized film, hexagonal columnar cells will be theoretically formed, each cell having a base in the shape of a regular hexagon centered on a micropore, and that the lines connecting neighboring micropores will form equilateral triangles.

Known examples of applications for such anodized films having micropores include optical functional nanodevices, magnetic devices, luminescent supports and catalyst supports. For example, Patent Literature 1 describes that an anodized film is applied to a Raman spectrometer by sealing pores with a metal and generating localized plasmon resonance.

A method is known in which pits serving as starting points for micropore formation in anodizing treatment are formed prior to anodizing treatment for forming such micropores. Formation of such pits facilitates controlling the micropore arrangement and variations in pore diameter within desired ranges.

A self-ordering method that makes use of the self-ordering nature in the anodized film is known as a general method for forming pits. This is a method which enhances the orderliness by using the regularly arranging nature of micropores in the anodized film and eliminating factors that may disturb an orderly arrangement.

### Citation List

### Patent Literature

Patent Literature 1: JP 2007-231336 A;

### SUMMARY OF THE INVENTION

### Problems to be Solved by the Invention

However, according to the self-ordering method described in Patent Literature 1, the film growth rate of the anodized film cannot be kept at a rate necessary to form a honeycomb array at an average pore density of 15 pores/μm² or less, that is, at a distance between centroids of neighboring micropores of at least 300 nm, and it has been difficult to grow the film in the axial direction of the micropores while maintaining the structure of the regularly arranged micropores.

The self-ordering method described in Patent Literature 1 has usually required an extended time period of several hours.

### Means for Solving the Problems

The inventors of the present invention have made an intensive study to solve the problems as described above and found that a microstructure with a thickness of at least 100 μm can be manufactured without broking the honeycomb array of micropores by performing constant current anodizing treatment after constant voltage anodizing treatment instead of a constant voltage anodizing treatment step. The present invention has been thus completed.

Accordingly, the present invention provides the following (i) to (iv).

(i) A microstructure comprising an aluminum or aluminum alloy oxide film which has cylindrical micropores extending from a bottom surface to a top surface of the microstructure, wherein the micropores are arrayed at the bottom surface so as to have a degree of ordering as defined by general formula (1):

Degree of ordering(%)=B/A×100(i) General formula (1)

(wherein A represents the total number of micropores in a measurement region, and B represents the number of specific micropores in the measurement region for which, when a circle is drawn so as to be centered on the center of gravity of a specific micropore and so as to be of the smallest radius that is internally tangent to the edge of another micropore, the circle includes centers of gravity of six micropores other than the specific micropore) of at least 70%, a center-to-center distance between neighboring micropores is from 300 to 600 nm and an axial length of the micropores is at least 100 μm.

The “center-to-center distance between neighboring micropores” (pitch) as used herein refers to a distance between the center of a specific cylindrical micropore in a cross section perpendicular to the long axis of the specific micropore and the center of another micropore closest to the specific micropore. The “center” refers to a center of gravity of the specific micropore in the cross section perpendicular to the long axis thereof when the cross sectional shape is not a perfect circle. The average pitch refers to an average within the measurement field of view.

The bottom surface refers to a surface or a plane of a microstructure which is perpendicular to the axes of cylindrical micropores, is closer to an aluminum or aluminum alloy plate when the microstructure is manufactured from the aluminum or aluminum alloy plate and is obtained by removing the aluminum or aluminum alloy plate.

(ii) The microstructure according to (i), wherein the degree of ordering of the micropores as defined by general formula (1) is different between a top surface and the bottom surface of the microstructure by up to 10%.

(iii) The microstructure according to (i), wherein the micropores extend or do not extend through the microstructure.

(iv) A method of manufacturing the microstructure according to any one of (i) to (iii), comprising the steps of: anodizing an aluminum or aluminum alloy plate in an aqueous acid solution while controlling a voltage to a fixed value; and further anodizing the aluminum or aluminum alloy plate in an aqueous acid solution while controlling a current to a fixed value.

By filling the micropores with a conductive material, the microstructure can be used as an anisotropic conductive film which has electrical conductivity in the perforating direction of the micropores (axial direction of the cylindrical micropores) and insulating properties on the plane perpendicular to the perforating direction of the micropores. The microstructure can also be used as a filter making use of the perforation structure and close packing structure.

### EFFECTS OF THE INVENTION

The present invention can provide a microstructure in which the degree of ordering as defined by general formula (1) is at least 70%, the center-to-center distance between neighboring micropores is from 300 to 600 nm, and the thickness of the micropores is at least 100 μm. By filling the micropores with a conductive material, the microstructure is expected to be used as an anisotropic conductive film which has electrical conductivity in the perforating direction of the micropores and insulating properties on the plane perpendicular to the perforating direction of the micropores. The microstructure is also expected to be used as a microfilter making use of the uniformity of the micropore size, close packing structure and straight tube structure of the micropores. The manufacturing method of the invention can facilitate simple and industrially easy manufacture of the microstructure.

### BRIEF DESCRIPTION OF THE DRAWINGS

FIGS. 1A and 1B are simplified views showing a preferred embodiment of an anisotropic conductive member of the invention; FIG. 1A being a front view and FIG. 1B being a cross-sectional view taken along the line IB-IB of FIG. 1A.

FIGS. 2A and 2B are diagrams illustrating a method for computing the degree of ordering of micropores.

FIGS. 3A to 3D are schematic end views for illustrating anodizing treatment in the manufacturing method of the invention.

### DESCRIPTION OF THE EMBODIMENTS

The invention is described more fully below.

[Microstructure]

The microstructure of the invention comprises an aluminum or aluminum alloy oxide film having micropores.

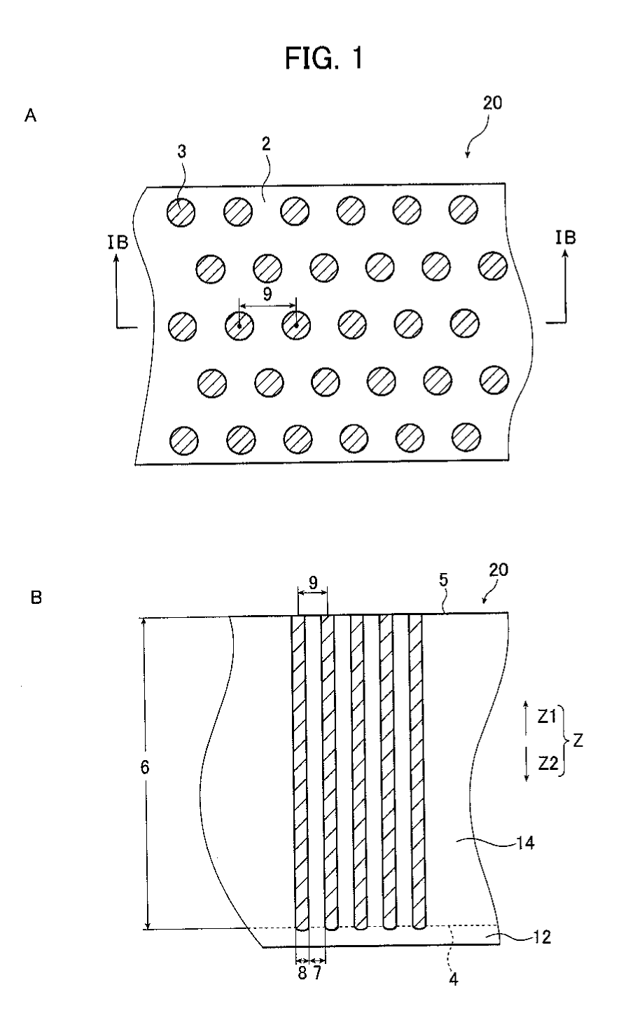

Next, the microstructure of the invention is described by reference to FIG. 1.

FIG. 1 shows simplified views of a preferred embodiment of a microstructure of the invention. FIG. 1A is a front view and FIG. 1B is a cross-sectional view taken along the line IB-IB of FIG. 1A.

A microstructure 1 of the invention includes an oxide film 2 and micropores 3.

As shown in FIG. 1B, each micropore 3 is cylindrical and is preferably formed substantially parallel (parallel in FIG. 1) to the thickness direction Z of the oxide film 2.

The center-to-center distance between neighboring micropores 3 of the microstructure 1 of the invention (as represented by reference symbol 9 in FIGS. 1A and 1B) is from 300 to 600 nm and preferably from 350 to 550 nm.

In the practice of the invention, the axial length of the cylindrical micropores which is the thickness of the oxide film (as represented by reference symbol 6 in FIG. 1B) is at least 100 μm, preferably from 100 to 1500 μm and more preferably from 100 to 1000 μm. When the center-to-center distance between neighboring micropores and the axial length fall within the above-defined ranges, the anisotropic conductive film preferably has sufficient insulating properties and electrical conductivity.

The average micropore density is preferably from 3.5 to 15 micropores/μm². At an average micropore density within the above-defined range, the anisotropic conductive film preferably has sufficient insulating properties.

The oxide film 2 making up the microstructure of the invention is obtained from an aluminum or aluminum alloy plate and is preferably formed by anodization.

In the practice of the invention, the distance between neighboring micropores (as represented by reference symbol 7 in FIG. 1B) is preferably from 10 to 590 nm and more preferably from 40 to 560 nm. The micropores preferably have a diameter (as represented by reference symbol 8 in FIG. 1B) of from 10 to 590 nm and more preferably from 40 to 560 nm.

In the practice of the invention, the microstructure 1 has the micropores arrayed at the bottom surface so as to have a degree of ordering as defined by general formula (1) of at least 70%. The bottom surface refers to a surface or a plane of a microstructure which is perpendicular to the axes of a plurality of cylindrical micropores, is closer to an aluminum or aluminum alloy plate when the microstructure is manufactured from the aluminum or aluminum alloy plate and is obtained by removing the aluminum or aluminum alloy plate. The bottom surface is a plane 4 on the side represented by reference symbol Z2 in FIG. 1B. The surface opposite from the bottom surface 4 of the microstructure 1 is a top surface 5 which is a plane on the side represented by reference symbol Z1 in FIG. 1B.

According to the microstructure manufacturing method of the invention to be described later, the degree of ordering of the micropores at the bottom surface is measured as follows: constant current treatment is followed by film dissolution; the bottom surface is observed with a scanning electron microscope; the number of given micropores is visually checked in the observed image to calculate the degree of ordering from general formula (1). The shape of portions serving as the starting points of final constant current anodizing treatment may be observed to determine the degree of ordering in the same manner.

In a preferred embodiment of the invention, the degree of ordering of the micropores as defined by general formula (1) is different between the top surface and the bottom surface of the microstructure by up to 10%. The difference is more preferably up to 5% and even more preferably up to 2%.

Degree of ordering(%)=B/A×100 (1)

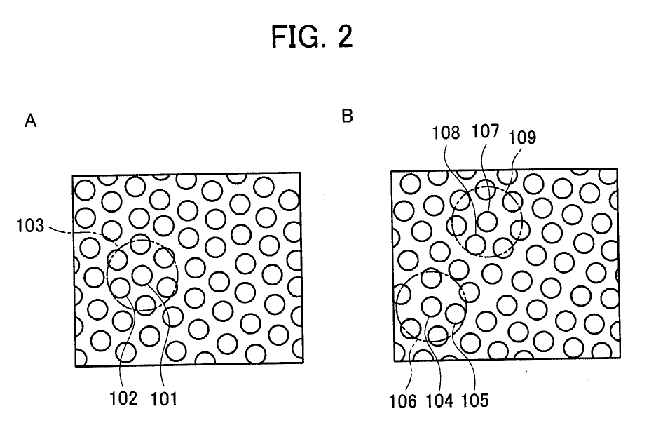

FIG. 2 illustrates a method for computing the degree of ordering of micropores. Above formula (1) is explained more fully below by reference to FIG. 2.

In the case of a first micropore 101 shown in FIG. 2A, when a circle 103 is drawn so as to be centered on the center of gravity of the first micropore 101 and so as to be of the smallest radius that is internally tangent to the edge of another micropore (inscribed in a second micropore 102), the interior of the circle 3 includes the centers of six micropores other than the first micropore 101. Therefore, the first micropore 101 is included in B.

In the case of a first micropore 104 shown in FIG. 2B, when a circle 106 is drawn so as to be centered on the center of gravity of the first micropore 104 and so as to be of the smallest radius that is internally tangent to the edge of another micropore (inscribed in a second micropore 105), the interior of the circle 106 includes the centers of gravity of five micropores other than the first micropore 104. Therefore, the first micropore 104 is not included in B.

In the case of a first micropore 107 shown in FIG. 2B, when a circle 109 is drawn so as to be centered on the center of gravity of the first micropore 107 and so as to be of the smallest radius that is internally tangent to the edge of another micropore (inscribed in a second micropore 108), the interior of the circle 109 includes the centers of gravity of seven micropores other than the first micropore 107. Therefore, the first micropore 107 is not included in B.

The microstructure is expected to be used as an anisotropic conductive film by filling the micropores with a metal by electrolytic plating or electroless plating. The microstructure is also expected to be used as a microfilter which has micropores reaching the bottom surface as a result of immersion of the microstructure in an alkali solution.

The microstructure of the invention may be manufactured by performing, for example, (a) constant voltage anodizing treatment followed by (b) constant current anodizing treatment.

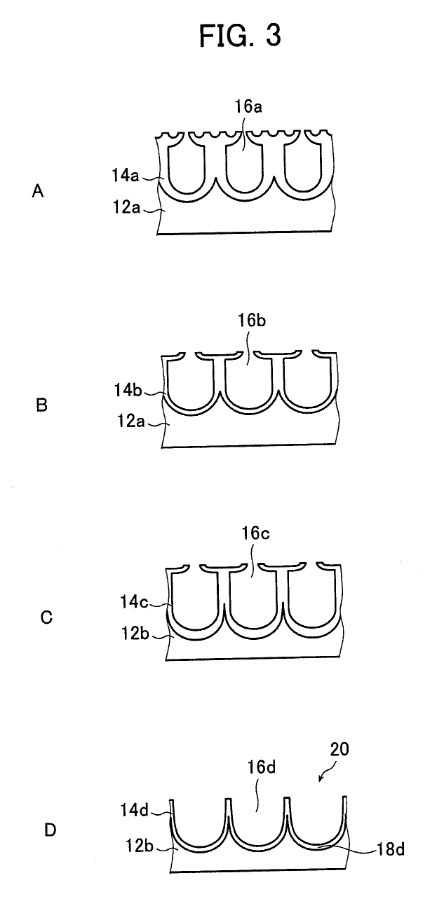

FIG. 3 shows schematic cross-sectional views of an aluminum member and a microstructure for illustrating the microstructure manufacturing method of the invention.

[Aluminum Substrate]

The aluminum or aluminum alloy substrate that may be used is not subject to any particular limitation. Illustrative examples include pure aluminum plate; alloy plates composed primarily of aluminum and containing trace amounts of other elements; substrates made of low-purity aluminum (e.g., recycled material) on which high-purity aluminum has been vapor-deposited; substrates such as silicon wafers, quartz or glass whose surface has been covered with high-purity aluminum by a process such as vapor deposition or sputtering; and resin substrates on which aluminum has been laminated.

Of the aluminum substrate, the surface on which an anodized film is to be formed by anodizing treatment has an aluminum purity of preferably at least 99.5 wt %, more preferably at least 99.9 wt % and even more preferably at least 99.99 wt %. At an aluminum purity within the above-defined range, the array of the micropores is well ordered.

The surface of the aluminum substrate is preferably subjected beforehand to degreasing treatment and mirror-like finishing treatment.

[Mirror-Like Finishing Treatment]

Mirror-like finishing treatment is carried out to eliminate surface topographic features of the aluminum substrate and improve the uniformity and reproducibility of particle-forming treatment using, for example, electrodeposition. Exemplary surface topographic features of the aluminum member include rolling streaks formed during rolling of the aluminum member which requires a rolling step for its manufacture.

In the invention, mirror-like finishing treatment is not subject to any particular limitation, and may be carried out using any suitable method known in the art. Examples of suitable methods include mechanical polishing, chemical polishing, and electrolytic polishing.

Illustrative examples of suitable mechanical polishing methods include polishing with various commercial abrasive cloths, and methods that combine the use of various commercial abrasives (e.g., diamond, alumina) with buffing. More specifically, illustrative methods that may be preferably used include a method using an abrasive and a method which is carried out while changing over time the abrasive used from one having coarser particles to one having finer particles. In such a case, the final abrasive used is preferably one having a grit size of 1500. In this way, a glossiness of at least 50% (in the case of rolled aluminum, at least 50% in both the rolling direction and the transverse direction) can be achieved.

Examples of chemical polishing methods include various methods mentioned in the 6th edition of Aluminum Handbook (Japan Aluminum Association, 2001), pp. 164-165.

Preferred examples include phosphoric acid/nitric acid method, Alupol I method, Alupol V method, Alcoa R5 method, H₃PO₄—CH₃COOH—Cu method and H₃PO₄—HNO₃—CH₃COOH method. Of these, the phosphoric acid/nitric acid method, the H₃PO₄—CH₃COOH—Cu method and the H₃PO₄—HNO₃—CH₃COOH method are especially preferred.

With chemical polishing, a glossiness of at least 70% (in the case of rolling, at least 70% in both the rolling direction and the transverse direction) can be achieved.

Examples of electrolytic polishing methods include various methods mentioned in the 6th edition of Aluminum Handbook (Japan Aluminum Association, 2001), pp. 164-165;

the method described in U.S. Pat. No. 2,708,655; and

the method described in Jitsumu Hyomen Gijutsu (Practice of Surface Technology), Vol. 33, No. 3, pp. 32-38 (1986).

With electrolytic polishing, a glossiness of at least 70% (in the case of rolled aluminum, at least 70% in both the rolling direction and the transverse direction) can be achieved.

These methods may be suitably combined and used. In an illustrative method that may be preferably used, polishing carried out by changing the abrasive used over time from one having coarser particles to one having finer particles is followed by electrolytic polishing.

Mirror-like finishing treatment enables a surface having, for example, a mean surface roughness Rₐ of 0.1 μm or less and a glossiness of at least 50% to be obtained. The mean surface roughness Rₐ is preferably 0.03 μm or less and more preferably 0.02 μm or less. The glossiness is preferably at least 70%, and more preferably at least 80%.

The glossiness is the specular reflectance which can be determined in accordance with JIS Z8741-1997 (Method 3: 60° Specular Gloss) in a direction perpendicular to the rolling direction. Specifically, measurement is carried out using a variable-angle glossmeter (e.g., VG-1D, manufactured by Nippon Denshoku Industries Co., Ltd.) at an angle of incidence/reflection of 60° when the specular reflectance is 70% or less, and at an angle of incidence/reflection of 20° when the specular reflectance is more than 70%.

[Degreasing Treatment]

Degreasing treatment is carried out with a suitable substance such as an acid, alkali or organic solvent so as to dissolve and remove organic substances, including dust, grease and resins, adhering to the aluminum surface, and thereby prevent defects due to organic substances from arising in each of the subsequent treatments. Degreasing treatment is also used for the purpose of removing the oxide film formed in mirror-like finishing.

Known degreasers may be used in degreasing treatment. For example, degreasing treatment may be carried out using any of various commercially available degreasers by the prescribed method.

Exemplary methods that may be preferably used include:

a method in which an organic solvent such as an alcohol (e.g., methanol), ketone, petroleum benzin or volatile oil is contacted with the aluminum surface at ambient temperature (organic solvent method); a method in which an organic solvent such as acetone is contacted with the aluminum surface at ambient temperature and ultrasonic waves are used (ultrasonic cleaning method); a method in which a liquid containing a surfactant such as soap or a neutral detergent is contacted with the aluminum surface at a temperature of from ambient temperature to 80° C., after which the surface is rinsed with water (surfactant method); a method in which an aqueous sulfuric acid solution having a concentration of 10 to 200 g/L is contacted with the aluminum surface at a temperature of from ambient temperature to 70° C. for a period of 30 to 80 seconds, following which the surface is rinsed with water; a method in which an aqueous solution of sodium hydroxide having a concentration of 5 to 20 g/L is contacted with the aluminum surface at ambient temperature for about 30 seconds while electrolysis is carried out by passing a direct current through the aluminum surface as the cathode at a current density of 1 to 10 A/dm², following which the surface is contacted with an aqueous solution of nitric acid having a concentration of 100 to 500 g/L and thereby neutralized; a method in which any of various known anodizing electrolytic solutions is contacted with the aluminum surface at ambient temperature while electrolysis is carried out by passing a direct current at a current density of 1 to 10 A/dm² through the aluminum surface as the cathode or by passing an alternating current through the aluminum surface as the cathode; a method in which an aqueous alkali solution having a concentration of 10 to 200 g/L is contacted with the aluminum surface at 40 to 50° C. for 15 to 60 seconds, following which an aqueous solution of nitric acid having a concentration of 100 to 500 g/L is contacted with the surface and thereby neutralized; a method in which an emulsion prepared by mixing a surfactant, water and the like into an oil such as gas oil or kerosene is contacted with the aluminum surface at a temperature of from ambient temperature to 50° C. for 30 to 180 seconds, following which the surface is rinsed with water (emulsion degreasing method); and a method in which a mixed solution of, for example, sodium carbonate, phosphates and surfactant is contacted with the aluminum surface at a temperature of from ambient temperature to 50° C. for 30 to 180 seconds, following which the surface is rinsed with water (phosphate method).

[Method of Forming Micropore Starting Points]

Any conventionally known method may be used to form starting points of micropores. More specifically, a self-ordering method to be described layer is preferably used.

The self-ordering method is a method which enhances the orderliness by using the regularly arranging nature of micropores in an anodized film and eliminating factors that may disturb an orderly arrangement. To be more specific, high-purity aluminum is used to form an anodized film at a voltage suitable to the type of electrolytic solution.

In this method, because the micropore size depends on the voltage, a desired micropore size can be obtained to some extent by controlling the voltage.

The average flow velocity of electrolytic solution in anodizing treatment is preferably from 0.5 to 20.0 m/min, more preferably from 1.0 to 15.0 m/min, and even more preferably from 2.0 to 10.0 m/min. By carrying out anodization at the flow velocity within the above-defined range, a uniform and high degree of ordering can be achieved.

The method for causing the electrolytic solution to flow under the above conditions is not subject to any particular limitation. For example, a method involving the use of a common agitator such as a stirrer may be employed. The use of a stirrer in which the stirring speed can be controlled with a digital display is desirable because it enables the average flow velocity to be regulated. An example of such a stirrer is the Magnetic Stirrer HS-50D (manufactured by As One Corporation).

Anodizing treatment is carried out at a constant voltage. The treatment voltage is preferably from 120 to 240 V and the average micropore density suitable for the treatment voltage is from 3.5 to 15 micropores/μm².

The electrolytic solution that may be used in anodizing treatment preferably contains an inorganic acid such as sulfuric acid or phosphoric acid, an organic acid such as oxalic acid, malonic acid, tartaric acid or succinic acid, or a mixture of two of the above acids.

The anodizing treatment conditions vary depending on the electrolytic solution employed, and thus cannot be strictly specified. However, the following conditions are generally preferred: an electrolyte concentration of from 0.1 to 5.0 M/L and a solution temperature of from −10 to 30° C. An electrolyte concentration of from 0.5 to 5.0 M/L and a solution temperature of from 0 to 20° C. are more preferred. A voltage of from 100 to 300 V and an electrolysis time of from 0.5 to 30 hours are preferred.

The average micropore density is preferably up to 15 micropores/μm² and more preferably from 3.5 to 15 micropores/μm².

[Ordering Treatment]

Ordering treatment is a treatment in which a step including film dissolution treatment for dissolving the anodized film and its subsequent anodizing treatment is performed once or more.

[Film Dissolution Treatment]

Film dissolution treatment is a treatment for dissolving the anodized film obtained from the aluminum member. This treatment dissolves part of the anodized film surface with irregular arrangement and therefore enhances the orderliness of the array of micropores. Dissolution of the film increases the rate of rise of the current density during anodizing treatment following a first film dissolution, thus leading to an increase in the orderliness of the micropore array.

Film dissolution treatment is carried out by bringing the aluminum member into contact with an aqueous acid or alkali solution. Examples of the contacting method include, but are not limited to, immersion and spraying. Of these, immersion is preferred.

When film dissolution treatment is to be carried out with an aqueous acid solution, it is preferable to use an aqueous solution of an inorganic acid such as sulfuric acid, phosphoric acid, nitric acid or hydrochloric acid, or a mixture thereof. It is particularly preferable to use an aqueous solution containing no chromic acid in terms of its high degree of safety. The aqueous acid solution preferably has a concentration of 1 to 10 wt %. The aqueous acid solution preferably has a temperature of 25 to 40° C.

When film dissolution treatment is to be carried out with an aqueous alkali solution, it is preferable to use an aqueous solution of at least one alkali selected from the group consisting of sodium hydroxide, potassium hydroxide and lithium hydroxide. The aqueous alkali solution preferably has a concentration of 0.1 to 5 wt %. The aqueous alkali solution preferably has a temperature of 20 to 35° C.

Specific examples of preferred solutions include a 40° C. aqueous solution containing 50 g/L of phosphoric acid, a 30° C. aqueous solution containing 0.5 g/L of sodium hydroxide, and a 30° C. aqueous solution containing 0.5 g/L of potassium hydroxide.

The time of immersion in the aqueous acid solution or aqueous alkali solution is preferably from 8 to 60 minutes, more preferably from 10 to 50 minutes and even more preferably from 15 to 30 minutes.

[Anodizing Treatment]

The above-described film dissolution treatment is followed by anodizing treatment. Oxidation reaction of the aluminum substrate thus proceeds to increase the thickness of the anodized film dissolved by film dissolution treatment.

Conventionally known methods may be used for anodizing treatment but anodizing treatment is preferably carried out under the same conditions as those of the above-described self-ordering method.

In anodizing treatment at a constant voltage, the electrolysis time is preferably from 30 seconds to 2 hours, more preferably from 30 seconds to 30 minutes and even more preferably from 30 seconds to 5 minutes. The voltage is preferably set to a constant value and is controlled in a fluctuation range of ±0.1 to 0.05 V.

In ordering treatment, a step including the above-described film dissolution treatment and its subsequent anodizing treatment may be performed once or more. The larger the number of repetitions is, the more the orderliness of the array of micropores is enhanced. In this regard, this step is repeatedly performed preferably twice or more, more preferably three times or more, and even more preferably four times or more.

When this step is repeatedly performed twice or more in ordering treatment, the conditions of the film dissolution treatment steps and the anodizing treatment steps in the respective cycles may be the same or different.

For example, FIG. 3A shows an aluminum substrate 12a and an anodized film 14a having micropores 16a which is present on a surface of the aluminum substrate 12a. Then, as shown in FIG. 3B, a first film dissolution treatment step causes the surface of the anodized film 14a and the interior of the micropores 16a shown in FIG. 3A to dissolve to thereby form an anodized film 14b having micropores 16b on the aluminum substrate 12a, the anodized film 14b still remaining at the bottom of the micropores 16b. By carrying out the subsequent anodizing treatment, oxidation reaction of the aluminum substrate 12a shown in FIG. 3B proceeds to obtain, as shown in FIG. 3C, an anodized film 14c which is formed on the aluminum substrate 12b, has micropores 16c with a larger depth than the micropores 16b and is thicker than the anodized film 14b. As shown in FIG. 3D, a second film dissolution treatment step causes the surface of the anodized film 14c and the interior of the micropores 16c shown in FIG. 3C to dissolve to thereby obtain a microstructure 20 having on the aluminum substrate 12b an anodized film 14d having micropores 16d. The barrier layer is shown by reference symbol 18d. In FIG. 3D, the anodized film 14d still remains but the anodized film may be thoroughly dissolved in the second film dissolution treatment step. In cases where the anodized film is thoroughly dissolved, pits present at the aluminum substrate surface serve as the micropores of the microstructure.

[Constant Current Treatment]

Constant current treatment is performed after the above-described anodizing treatment. This treatment enables the aluminum oxide film to have a larger thickness while increasing the axial length of the micropores without deteriorating the ordered array.

In anodizing treatment at a constant current following anodizing treatment at a constant voltage, the electrolysis time is preferably from 5 minutes to 30 hours and more preferably from 30 minutes to 5 hours. The current is preferably set to a constant value and is preferably controlled in a fluctuation range of ±10 to 1 A/m².

The type and concentration of the electrolytic solution used in constant current treatment and anodizing treatment, and the temperature conditions may be the same or different.

In anodizing treatment at a constant current following anodizing treatment at a constant voltage, the current density is preferably from 0 to 10000 A/m², more preferably from 0 to 1000 A/m², and most preferably from 0 to 400 A/m².

The microstructure of the invention is obtained by the above-described manufacturing method of the invention. In addition, the aluminum or aluminum alloy substrate for the microstructure of the invention may be removed as will be described later or through micropore-forming treatment may be further performed.

[Perforating Treatment]

Perforating treatment is a treatment in which micropores formed by anodization in the above-described anodizing treatment are made to extend through the microstructure.

In the perforating treatment step, treatment (2-a) or (2-b) is preferably carried out.

(2-a) Treatment (chemical dissolution treatment) in which an acid or an alkali is used to dissolve the aluminum substrate having the anodized film formed thereon to make the micropores extend through the anodized film.
(2-b) Treatment (mechanical polishing treatment) in which the aluminum substrate having the anodized film formed thereon is mechanically polished to make the micropores extend through the anodized film.

### [(2-a) Chemical Dissolution Treatment]

More specifically, chemical dissolution treatment which follows the anodizing treatment step involves, for example, dissolving the aluminum substrate (portion represented by reference symbol 12b in FIG. 3D) and further removing the bottom of the anodized film (portion represented by reference symbol 18d in FIG. 3D) to make the micropores extend through the anodized film.

[Dissolution of Aluminum Substrate]

A treatment solution which does not readily dissolve the anodized film (alumina) but readily dissolves aluminum is used for dissolution of the aluminum substrate after anodizing treatment at a constant current.

That is, use is made of a treatment solution which has an aluminum dissolution rate of at least 1 μm/min, preferably at least 3 μm/min, and more preferably at least 5 μm/min, and has an anodized film dissolution rate of 0.1 nm/min or less, preferably 0.05 nm/min or less, and more preferably 0.01 nm/min or less.

Specifically, a treatment solution which includes at least one metal compound having a lower ionization tendency than aluminum, and which has a pH of 4 or less or 8 or more, preferably 3 or less or 9 or more, and more preferably 2 or less or 10 or more is used to perform immersion treatment.

Preferred examples of such treatment solutions include solutions which are composed of, as the base, an aqueous solution of an acid or an alkali and which have blended therein a compound of, for example, manganese, zinc, chromium, iron, cadmium, cobalt, nickel, tin, lead, antimony, bismuth, copper, mercury, silver, palladium, platinum or gold (e.g., chloroplatinic acid), or a fluoride or chloride of any of these metals.

Of the above, it is preferable for the treatment solution to be based on an aqueous solution of an acid and to have blended therein a chloride compound.

Treatment solutions of an aqueous solution of hydrochloric acid in which mercury chloride has been blended (hydrochloric acid/mercury chloride), and treatment solutions of an aqueous solution of hydrochloric acid in which copper chloride has been blended (hydrochloric acid/copper chloride) are especially preferred from the standpoint of the treatment latitude.

There is no particular limitation on the composition of such treatment solutions. Illustrative examples of the treatment solutions that may be used include a bromine/methanol mixture, a bromine/ethanol mixture, and aqua regia.

Such a treatment solution preferably has an acid or alkali concentration of 0.01 to 10 mol/L and more preferably 0.05 to 5 mol/L. In addition, such a treatment solution is used at a treatment temperature of preferably −10° C. to 80° C. and more preferably 0 to 60° C.

In the manufacturing method of the invention, dissolution of the aluminum substrate is carried out by bringing the aluminum substrate having undergone the anodizing treatment step into contact with the above-described treatment solution. Examples of the contacting method include, but are not limited to, immersion and spraying. Of these, immersion is preferred. The period of contact in this process is preferably from 10 seconds to 5 hours and more preferably from 1 minute to 3 hours.

[Removal of Bottom of Anodized Film]

The bottom of the anodized film after the dissolution of the aluminum substrate is removed by immersion in an aqueous acid or alkali solution. Removal of the bottom of the anodized film causes the micropores to extend therethrough.

The bottom of the anodized film is preferably removed by the method that involves previously immersing the anodized film in a pH buffer solution to fill the micropores with the pH buffer solution from the micropore opening side, and bringing the surface opposite from the openings (i.e., the bottom of the anodized film) into contact with an aqueous acid solution or aqueous alkali solution.

When this treatment is to be carried out with an aqueous acid solution, it is preferable to use an aqueous solution of an inorganic acid such as sulfuric acid, phosphoric acid, nitric acid or hydrochloric acid, or a mixture thereof. The aqueous acid solution preferably has a concentration of 1 to 10 wt %. The aqueous acid solution preferably has a temperature of 25 to 40° C.

When this treatment is to be carried out with an aqueous alkali solution, it is preferable to use an aqueous solution of at least one alkali selected from the group consisting of sodium hydroxide, potassium hydroxide and lithium hydroxide. The aqueous alkali solution preferably has a concentration of 0.1 to 5 wt %. The aqueous alkali solution preferably has a temperature of 20 to 35° C.

Specific examples of solutions that may be preferably used include a 40° C. aqueous solution containing 50 g/L of phosphoric acid, a 30° C. aqueous solution containing 0.5 g/L of sodium hydroxide, and a 30° C. aqueous solution containing 0.5 g/L of potassium hydroxide.

The time of immersion in the aqueous acid solution or aqueous alkali solution is preferably from 8 to 120 minutes, more preferably from 10 to 90 minutes and even more preferably from 15 to 60 minutes.

In cases where the film is previously immersed in a pH buffer solution, a buffer solution suitable to the foregoing acids/alkalis is used.

### [(2-b) Mechanical Polishing Treatment]

More specifically, mechanical polishing treatment which follows the anodizing treatment step involves, for example, mechanically polishing and removing the aluminum substrate (portion represented by reference symbol 12b in FIG. 3D) and the anodized film in the vicinity of the aluminum substrate (portion represented by reference symbol 18d in FIG. 3D) to make the micropores extend through the anodized film.

A wide variety of known mechanical polishing treatment methods may be used for mechanical polishing treatment and, for example, mechanical polishing illustrated for mirror-like finishing treatment may be used. However, chemical mechanical polishing (CMP) is preferably carried out owing to its high fine polishing rate. CMP treatment may be carried out using a CMP slurry such as PNANERLITE-7000 available from Fujimi Inc., GPX HSC800 available from Hitachi Chemical Co., Ltd., or CL-1000 available from AGC Seimi Chemical Co., Ltd.

These perforating treatment steps yield a structure shown in FIG. 3D after removal of the aluminum substrate 12b and the barrier layer 18d, that is, a microstructure having the micropores extending therethrough.

### EXAMPLES

Next, the present invention is described by referring to the Examples, which by no means limit the scope of the invention.

### Example 1

### 1. Electrolytic Polishing

A high-purity aluminum substrate (Sumitomo Light Metal Industries, Ltd.; purity, 99.99 wt %; thickness, 0.4 mm) was cut to a size of 10 cm square, and then subjected to electrolytic polishing using an electrolytic polishing solution of the composition indicated below at a voltage of 10 V and a solution temperature of 65° C. A carbon electrode was used as the cathode, and a GPO-250-30R unit (Takasago, Ltd.) was used as the power supply.

[Electrolytic Polishing Solution Composition]

| | |
|---|---|
| 85 wt % Phosphoric acid (Wako Pure Chemical | 1320 mL |
| Industries, Ltd.) | |
| Pure water | 80 mL |
| Sulfuric acid | 600 mL |

### 2. Degreasing Treatment

A sample obtained after polishing treatment was degreased by immersion at 60° C. for 30 to 90 seconds in a treatment solution containing 1.75 mol/L sodium hydroxide and 0.16 mol/L sodium nitrate.

### 3. (A) Starting Point-Forming Treatment

The sample obtained as above was anodized in an electrolytic solution containing 5.00 mol/L malonic acid for 7.5 minutes under conditions of a voltage of 130.0 V and a solution temperature of 3° C. The voltage was set to a constant voltage mode using GPO-250-30R (Takasago, Ltd.) and controlled to a value of 130.0 V±0.1 V. The thus obtained sample was then immersed in an aqueous solution containing 0.52 mol/L phosphoric acid at 40° C. for 42.5 minutes to dissolve the film. This treatment was repeated four times.

### 4. (B) Anodizing Treatment

The sample obtained as above was anodized in an electrolytic solution containing 5.00 mol/L malonic acid for 7.5 minutes under conditions of a voltage of 130.0 V and a solution temperature of 3° C.

### 5. (C) Constant Current Treatment

The thus obtained sample was subjected to constant current anodizing treatment using the same type of electrolytic solution containing malonic acid for 90 minutes under conditions of a current density of 120 A/m² and a solution temperature of 3° C. A current transformer and a voltmeter were used to measure the current flowing through the conductor portions and the current was controlled to a value of 120 A/m²±10 A/m².

An anodized film as shown in FIG. 1B in which straight tube-shaped micropores were arranged in a honeycomb array on the surface of the aluminum substrate was formed.

### Example 2

Example 1 was repeated except that micropore-forming treatment by means of starting point-forming treatment (A) was performed by anodization in an electrolytic solution containing 0.1 mol/L phosphoric acid for 240 minutes under conditions of a voltage of 195 V and a solution temperature of 3° C.; micropore-forming treatment by means of anodizing treatment (B) was performed by constant voltage anodization in 0.5 mol/L phosphoric acid for 30 minutes under conditions of a voltage of 195 V and a temperature of 3° C.; and micropore-forming treatment by means of constant current treatment (C) was performed by constant current anodization in an electrolytic solution containing 0.5 mol/L phosphoric acid for 720 minutes under conditions of a current density of 200 A/m² and a solution temperature of 3° C., thereby obtaining a sample in Example 2.

### Example 3

Example 1 was repeated except that micropore-forming treatment by means of starting point-forming treatment (A) was performed by anodization in an electrolytic solution containing 3.0 mol/L tartaric acid for 30 minutes under conditions of a voltage of 197 V and a solution temperature of 3° C.; micropore-forming treatment by means of anodizing treatment (B) was performed by constant voltage anodization in an electrolytic solution containing 5.0 mol/L tartaric acid for 2 minutes under conditions of a voltage of 197 V and a temperature of 3° C.; and micropore-forming treatment by means of constant current treatment (C) was performed by constant current anodization in an electrolytic solution containing 5.0 mol/L tartaric acid for 120 minutes under conditions of a current density of 180 A/m² and a solution temperature of 3° C., thereby obtaining a sample in Example 3.

### Example 4

Example 1 was repeated except that micropore-forming treatment by means of starting point-forming treatment (A) was performed by anodization in an electrolytic solution containing 2.0 mol/L citric acid for 10 minutes under conditions of a voltage of 240 V and a solution temperature of 3° C.; micropore-forming treatment by means of anodizing treatment (B) was performed by constant voltage anodization in an electrolytic solution containing 2.0 mol/L citric acid for 10 minutes under conditions of a voltage of 240 V and a temperature of 3° C.; and micropore-forming treatment by means of constant current treatment (C) was performed by constant current anodization in an electrolytic solution containing 0.5 mol/L tartaric acid for 300 minutes under conditions of a current density of 70 A/m² and a solution temperature of 3° C., thereby obtaining a sample in Example 4.

### Example 5

Example 1 was repeated except that micropore-forming treatment by means of constant current treatment (C) was performed by constant current anodization in an electrolytic solution containing 5.0 mol/L malonic acid for 150 minutes under conditions of a current density of 120 A/m² and a solution temperature of 3° C., thereby obtaining a sample in Example 5.

### Comparative Example 1

Example 1 was repeated except that micropore-forming treatment by means of anodizing treatment (B) was performed by constant voltage anodization at a voltage of 130 V for 150 minutes and no constant current anodization was performed, thereby obtaining a sample in Comparative Example 1.

### Comparative Example 2

Example 2 was repeated except that micropore-forming treatment by means of anodizing treatment (B) was performed by constant current anodization at a current density of 120 A/m² for 150 minutes and no constant voltage anodization was performed, thereby obtaining a sample in Comparative Example 2.

### Comparative Example 3

Example 1 was repeated except that micropore-forming treatment by means of starting point-forming treatment (A) was not performed, micropore-forming treatment by means of anodizing treatment (B) was performed by constant voltage anodization at a voltage of 130.0 V for 150 minutes and no constant current anodization was performed, thereby obtaining a sample in Comparative Example 3.

### Comparative Example 4

Example 1 was repeated except that micropore-forming treatment by means of starting point-forming treatment (A) was not performed, micropore-forming treatment by means of anodizing treatment (B) was performed by constant current anodization at a current density of 120 A/m² for 150 minutes and no constant voltage anodization was performed, thereby obtaining a sample in Comparative Example 4.

The results in Examples and Comparative Examples are shown in Table 1.

TABLE 1

| | | | | | Center-to- | | Degree | | | |
|---|---|---|---|---|---|---|---|---|---|---|
| | | | | | center | | of | Variance | Variance | |
| | Voltage in | Current in | | | distance | Degree of | ordering | of | of | |
| | constant | constant | | Micropore | between | ordering | at | average | average | Film |
| | voltage | current | Anodization | axial | neighboring | at top | bottom | pore size | pore size | growth |
| | anodization | anodization | solution | length | micropores | surface | surface | (top | (bottom | rate |
| | [V] | [A/m²] | [mol/L] | [μm] | [nm] | (%) | (%) | surface) | surface) | [μm/h] |
| EX 1 | 130 | 120 | malonic | 109 | 300 | 78 | 80 | 0.2 | 0.2 | 44 |
| | | | acid 5.0 | | | | | | | |
| EX 2 | 195 | 200 | phosphoric | 101 | 488 | 84 | 82 | 0.17 | 0.18 | 8 |
| | | | acid 0.5 | | | | | | | |
| EX 3 | 197 | 180 | tartaric | 103 | 486 | 78 | 79 | 0.21 | 0.19 | 52 |
| | | | acid 3.0 | | | | | | | |
| EX 4 | 240 | 70 | citric | 102 | 575 | 83 | 81 | 0.18 | 0.19 | 20 |
| | | | acid 2.0 | | | | | | | |
| EX 5 | 130 | 120 | malonic | 190 | 300 | 78 | 81 | 0.2 | 0.19 | 38 |
| | | | acid 5.0 | | | | | | | |
| CE 1 | 130 | — | malonic | 38 | 300 | 77 | 56 | 0.2 | 0.46 | 15 |
| | | | acid 5.0 | | | | | | | |
| CE 2 | — | 120 | malonic | — | — | — | — | — | — | — |
| | | | acid 5.0 | | | | | | | |
| CE 3 | 112.5 | — | malonic | 39 | 300 | 55 | 52 | 0.43 | 0.45 | 14 |
| | | | acid 5.0 | | | | | | | |
| CE 4 | — | 120 | malonic | — | — | — | — | — | — | — |
| | | | acid 5.0 | | | | | | | |

(1) The micropore size was determined as follows: The shape of micropores after dissolution in chromic acid to obtain the shapes of the starting points was observed in a scanning electron microscopic (SEM) image; the peripheral length of 20 micropores in the image was measured; the micropore size was calculated by dividing the micropore peripheral length by π assuming that the micropores had a perfect circle shape; and the average of the calculated values was determined. The variance of the average pore size was determined for each of the top and bottom surfaces and is shown in Table 1.
(2) The center-to-center distance between neighboring micropores was determined as follows: The film was dissolved to observe the shapes of starting points in an SEM image; neighboring two micropores were selected from the image; two straight lines were drawn so that each line intersected the pore periphery at two points; perpendicular bisectors were drawn to the straight lines defined by the pore periphery; the point of intersection of the two perpendicular bisectors was regarded as the center of each micropore and the center-to-center distance between the neighboring micropores was measured. This operation was repeated twenty times. The average was calculated to determine the center-to-center distance.
(3) The microstructure surface was observed in an SEM image; of 200 micropores, the number of micropores adjacent to six micropores was visually checked; and the degree of ordering at the top surface was calculated from general formula (1).
(4) The shape of micropores after dissolution to obtain the shapes of the starting points in chromic acid was observed in an SEM image; of 200 micropores, the number of micropores adjacent to six micropores was visually checked; and the degree of ordering at the bottom surface was calculated from general formula (1).
(5) The film thickness was measured with an eddy current film thickness meter and the film growth rate was calculated from the equation: film growth rate=(film thickness)/(AD processing time). Table 1 shows the film growth rate measured in the case of constant current anodizing treatment.
(6) The axial length of the micropores was measured with an eddy current film thickness meter EDY-1000 available from Sanko Electronic Laboratory Co., Ltd. The results are shown in Table 1.

### DESCRIPTION OF SYMBOLS

2 oxide film
3, 16a, 16b, 16c, 16d micropore
4 bottom surface
5 top surface
6 axial distance of micropores
7 distance between neighboring micropores
8 micropore diameter
9 center-to-center distance between neighboring micropores
12, 12a, 12b, 12c, 12d aluminum substrate
14, 14a, 14b, 14c, 14d anodized film
18d barrier layer
20 microstructure
101, 102, 104, 105, 107, 108 micropore
103, 106, 109 circle

1. A microstructure comprising an aluminum or aluminum alloy oxide film which has cylindrical micropores extending from a bottom surface to a top surface of the microstructure, wherein the micropores are arrayed at the bottom surface so as to have a degree of ordering as defined by general formula (1):
Degree of ordering(%)=B/A×100 General formula (1)
(wherein A represents a total number of micropores in a measurement region, and B represents a number of specific micropores in the measurement region for which, when a circle is drawn so as to be centered on a center of a specific micropore in a cross section perpendicular to a long axis of the specific micropore and so as to be of the smallest radius that is internally tangent to an edge of another micropore, the circle includes centers of six micropores other than the specific micropore) of at least 70%, a center-to-center distance between neighboring micropores is from 300 to 600 nm and an axial length of the micropores is at least 100 μm.

2. The microstructure according to claim 1, wherein the degree of ordering of the micropores as defined by general formula (1) is different between a top surface and the bottom surface of the microstructure by up to 10%.

3. A method of manufacturing the microstructure according to claim 1, comprising the steps of: anodizing an aluminum or aluminum alloy plate in an aqueous acid solution while controlling a voltage to a fixed value; and further anodizing the aluminum or aluminum alloy plate in an aqueous acid solution while controlling a current to a fixed value.

4. A method of manufacturing the microstructure according to claim 2, comprising the steps of: anodizing an aluminum or aluminum alloy plate in an aqueous acid solution while controlling a voltage to a fixed value; and further anodizing the aluminum or aluminum alloy plate in an aqueous acid solution while controlling a current to a fixed value.
